(19) United States
(12) Patent Application Publication
(10) Pub. No.: US 2006/0010881 A1
(43) Pub. Date: Jan. 19, 2006

(54) Cryogenic dewar

(76) Inventor: Keith Gustafson, Waleska, GA (US)

Correspondence Address: DLA PIPER RUDNICK GRAY CARY US LLP, P. O. BOX 64807, CHICAGO, IL, 60664-0807, US

(21) Appl. No.: 11/181,507

(22) Filed: Jul. 14, 2005

Related U.S. Application Data
(60) Provisional application No. 60/587,696, filed on Jul. 14, 2004.

(51) Int. Cl. F17C 5/02; F25B 19/00

(52) U.S. Cl. 62/47.1; 62/51.1

(57) ABSTRACT

A cryogenic dewar features an inner tank surrounded by an outer shell with the space there between vacuum-insulated. A pressure vessel containing a cryogenic liquid refrigerant, such as liquid nitrogen, is positioned at least partially within the interior of the dewar to cool it. The pressure vessel is pressurized so that the temperature of the cryogenic liquid may be controlled. A refrigeration device and temperature or pressure sensor communicate with the cryogenic liquid in the pressure vessel. When the sensor detects that the cryogenic liquid has warmed above a predetermined level, the refrigeration device is automatically activated to cool the cryogenic liquid.

### CLAIM OF PRIORITY

This application claims priority from U.S. Provisional Patent Application Ser. No. 60/587,696, filed Jul. 14, 2004.

### BACKGROUND OF THE INVENTION

The present invention relates generally to freezers or dewars for storing materials at low temperatures and, in particular, to a cryogenic dewar with a generally uniform and controllable temperature distribution.

When storing biological material in cryogenic freezers there is a desire to maintain the specimens at a uniform, controlled temperature. In addition to the temperature being uniform, the desired temperature itself varies with the type of material being stored and its intended use. For the long term storage of biological cells, for example, it is desirable to keep the temperature below −160° C. For short term storage of blood plasma, or transplant tissue, −50° C. is all that is required. To handle the different requirements for storage, cryogenic freezers have evolved along two separate paths, liquid nitrogen (or “LN2”) cooled or mechanically cooled.

A conventional LN2 cryogenic dewar is indicated in general at 10 in FIG. 1 and features an outer shell 12 housing an inner tank 14. The outer shell and inner tank are separated by vacuum-insulated space 16 and a removable insulated lid or plug 18 permits access to the interior of the inner tank. A number of stainless steel storage racks, one of which is illustrated at 22, holding boxes containing biological specimens are positioned inside the dewar. The racks rest on a circular turn tray platform 26. To access storage racks 22, a user rotates the tray 26 using handles 28. At the bottom of the dewar is a pool 32 of liquid nitrogen (−196° C) which keeps the biological specimens in the dewar cool.

With the dewar 10 of FIG. 1, the racks are not in direct contact with the liquid nitrogen, but rather reside in the vapor space above the liquid. The temperature of the racks thus varies with the distance from the liquid nitrogen. More specifically, the lowest temperatures are near the bottoms of the racks, nearest to the nitrogen pool, while the highest temperatures are near the tops of the racks, farthest from the pool. In early versions of such storage dewars, it is not uncommon to see 100° C. temperature differences from the top to the bottom of the dewar.

More modem dewars make use of thermally conductive materials for the racks and in the dewar construction to minimize this temperature stratification and make it close to the liquid nitrogen pool temperature from top to bottom. An example of such a dewar is presented in commonly owned U.S. Pat. No. 6,393,847 to Brooks et al. The Brooks et al. '847 patent discloses a dewar with a pool of liquid cryogen in the bottom and a turntable or rotatable tray featuring a cylindrical sleeve. The cylindrical sleeve features a skirt which extends down into the pool of liquid cryogen so as to transfer heat away from biological samples stored on the tray. While such anti-stratification methods work, the temperatures in the dewar tend to be close to LN2 temperature, making such dewars most suitable for long term storage applications.

Mechanical freezers work in much the same manner as a home freezer. An insulated container is cooled by an electrically-powered refrigeration system. These freezers are limited, however, in the temperature they can achieve by the efficiency of the insulation of the freezer and the refrigeration system itself. They tend to operate in the −40° C. to −100° C. temperature ranges.

The greatest disadvantage presented by mechanical freezers is their dependence on electricity to operate. If the power goes out or the refrigeration system fails, the freezer will warm up in a short period of time (a couple of days). With liquid nitrogen freezers, if the power fails or the liquid level controller fails, the pool of nitrogen in the bottom of the dewar will typically provide a month of refrigeration. For this reason, the freezer market tends to favor the use of liquid nitrogen freezers in situations that require low temperature storage or where high value materials are cooled. Mechanical freezers are used in situations that don't require extremely low temperatures or to cool contents that are more easily replaced.

Conventional liquid nitrogen freezers have two inherent problems maintaining uniform, yet selectable temperatures. First, as mentioned previously, the liquid nitrogen refrigerant is stored in the bottom of the freezer. Since cold gas is denser than warm gas, freezers with a nitrogen pool in the bottom naturally tend to stratify in temperature. All heat coming into the freezer warms the vapor which becomes less dense and rises to the top. Since most LN2 freezers have top openings, the majority of the heat coming into the freezer comes in at the top in the first place and isn't effectively absorbed by the liquid at the bottom. This adds to the stratification problem.

Second, the liquid nitrogen is stored at atmospheric pressure and hence it's temperature is always approximately −196° C. As a result, if you eliminate all of the stratification in the dewar, the temperature therein will be approximately −196° C.

It is therefore the object of the present invention to provide a cryogenic dewar that features generally uniform storage temperatures.

It is another object of the present invention to provide a cryogenic dewar that features selectable storage temperatures.

It is another object of the present invention to provide a cryogenic dewar that maintains refrigeration for long standby times in the event of mechanical failure.

It is still another object of the present invention to provide a cryogenic dewar that is economical to operate.

### SUMMARY OF THE INVENTION

The invention is directed to a cryogenic dewar with an inner tank defining an interior of a dewar and an outer shell surrounding the inner tank. A pressure vessel containing a pressurized cryogenic liquid refrigerant is positioned at least partly within the interior of the dewar. The pressure vessel cools the interior of the dewar so that biological samples or the like may be stored therein. The temperature of the refrigerant may be controlled via the pressure within the pressure vessel.

A refrigeration device communicates with the cryogenic liquid in the pressure vessel as does a pressure or temperature sensor. When the sensor detects that the temperature of cryogenic liquid has warmed above a predetermined level, the refrigeration device is activated to cool the cryogenic liquid in the pressure vessel.

The following detailed description of embodiments of the invention, taken in conjunction with the accompanying drawings and appended claims, provide a more complete understanding of the nature and scope of the invention.

### BRIEF DESCRIPTION OF THE DRAWINGS

FIG. 1 is a side sectional view of a prior art cryogenic dewar;

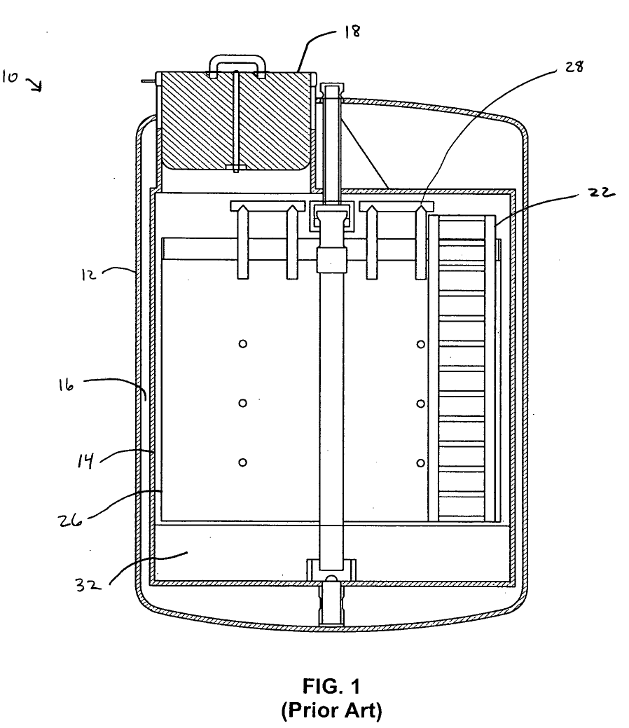

FIG. 2 is a side sectional view of a first embodiment of the cryogenic dewar of the present invention;

FIG. 3 is a side sectional view of a second embodiment of the cryogenic dewar of the present invention;

FIG. 4 is a side sectional view of a third embodiment of the cryogenic dewar of the present invention;

FIG. 5 is a side sectional view of a fourth embodiment of the cryogenic dewar of the present invention.

### DESCRIPTION OF THE PREFERRED EMBODIMENTS

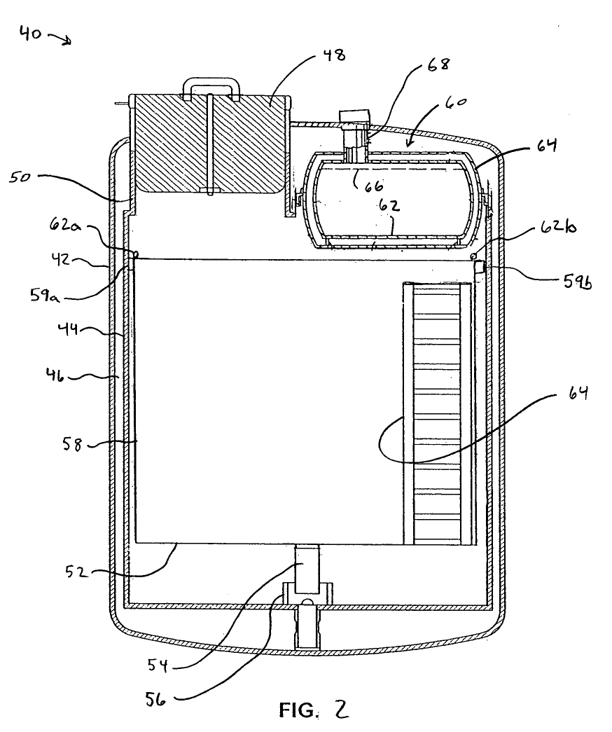

A first embodiment of the cryogenic dewar of the present invention is indicated in general at 40 in FIG. 2. The dewar features an outer shell 42 that surrounds an inner tank 44 with a vacuum-insulated space 46 there between. An insulated lid or plug 48 is removable to permit access to the interior of the dewar 40 via opening 50. The outer shell 42 and inner tank 44 are preferably constructed from stainless steel or aluminum.

A round turntable or rotatable tray 52 is mounted upon the bottom of the inner tank via a pivot 54 and a bearing 56. A cylindrical side wall 58 is attached to the periphery of the tray 52. A series of circumferentially-spaced rollers 59a and 59b are mounted around the top of the cylindrical side wall 58 and rotate about vertical axes. The rollers engage the interior surface of the inner tank 44 to guide the tray 52 and sidewall 58 as they rotate. A series of circumferentially-spaced handles 62a and 62b may be accessed by a user through opening 50 of the dewar to turn the turntable 52 and its cylindrical side wall 58.

A number of racks, such as the one illustrated at 64, may be positioned on tray 52. The tray 52 may be rotated by a user to access the racks through opening 50. The racks may be used to hold, for example, biological specimens. Such racks are well known in the art. An example of such a rack is disclosed in U.S. Pat. No. 5,226,715 to Delatte.

The turntable 52 and side wall 58 may be optionally replaced with a simple, non-rotating plate that covers the bottom of the inner tank 44 if the turntable feature is not necessary or desirable.

In the embodiment of FIG. 2, the liquid cryogen refrigerant, which is preferably liquid nitrogen, is stored in a pressure vessel, indicated in general at 60. The pressure vessel 60 preferably contains an inner tank 62 that is surrounded by outer shell 64. The space between the inner tank and outer shell may or may not be vacuum-insulated. A single wall pressure vessel may also be substituted for the double-walled pressure vessel illustrated in FIG. 2. The inner tank 62 and outer shell 64 are preferably constructed from aluminum or stainless steel and may feature a construction similar to cryogenic liquid cylinders offered by Chart Industries, Inc. of Canton, Ga. Liquid nitrogen 66 fills the inner tank 62. Pressurized liquid nitrogen may be added to the pressure vessel 60 via port 68 using methods and equipment well known in the art.

As illustrated in FIG. 2, the pressure cylinder 60 is attached to the top portion of the inner tank 44 so that it is disposed in the top portion of the dewar. As a result, natural convection works in the dewar's favor. The gas in contact with the pressure vessel at the top of the dewar will cool and sink to the bottom automatically, maintaining a uniform temperature below the pressure vessel.

Storing the cryogenic liquid refrigerant in the pressure vessel also provides two advantages. First, since the boiling temperature of the liquid cryogen refrigerant, the liquid nitrogen, is directly proportional to its pressure, the temperature of the liquid nitrogen, and hence the temperature of the dewar, can be adjusted by controlling the pressure in the pressure vessel 60. For example, liquid nitrogen at atmospheric pressure is −196° C., but at 125 psig, it is −170° C. Second, since the refrigerant fluid is stored in a pressure vessel and not in contact with the product being stored in the freezer, nitrogen doesn't have to be used as the refrigerant. Due to its reactivity, liquid oxygen couldn't be used in an open storage dewar, but if contained inside of a separate pressure vessel, it could make a useful refrigerant fluid for a higher temperature storage range. At room temperature, liquid oxygen is −183° C. and it warms to −150° C. at 125 psig. Liquid gasses like methane or other liquid gas mixtures could be used to achieve even higher temperatures.

The freezer or dewar of FIG. 2 still maintains it's long standby time since the bath of cryogenic liquid is still present.

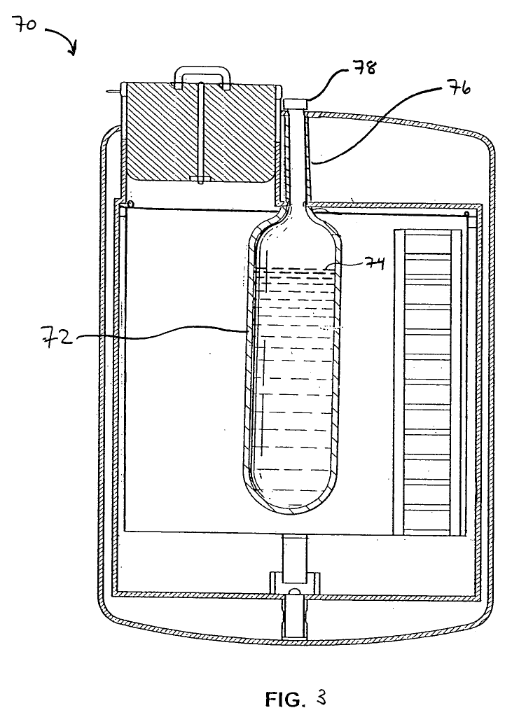

In a second embodiment of the cryogenic dewar of the present invention, indicated in general at 70 in FIG. 3, a separate pressure vessel 72 filled with liquid nitrogen 74 traverses the height of the interior of the dewar. While this embodiment permits an even more uniform temperature distribution in the dewar, it obviously carries a space penalty. While a single-walled pressure vessel is illustrated in FIG. 3, a double-walled version, similar to-the pressure vessel of FIG. 2, may be used instead. The pressure vessel 72 may be filled with pressurized liquid nitrogen, or another cryogenic liquid, through neck 76 and port 78 using methods and equipment well known in the art. The remaining portions of dewar 70 feature a construction similar to dewar 40 of FIG. 2.

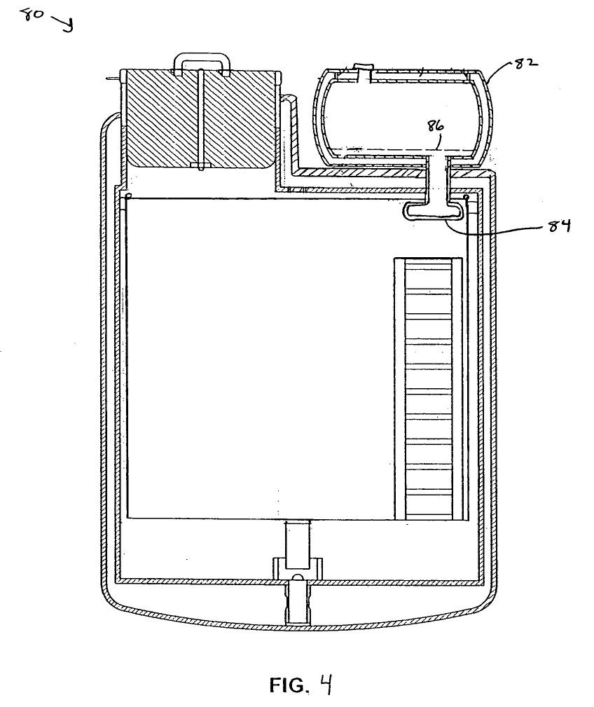

In a third embodiment of the cryogenic dewar of the present invention, indicated in general at 80 in FIG. 4, a cryogenic pressure vessel 82 is separately housed and communicates with the interior of the cryogenic dewar via a cold finger 84. The pressure vessel preferably is double-walled and features a construction similar to the pressure vessel 60 of FIG. 2. Pressurized liquid nitrogen 86 from the pressure vessel 82 fills the cold finger 84 so that the cold finger cools the interior of the dewar.

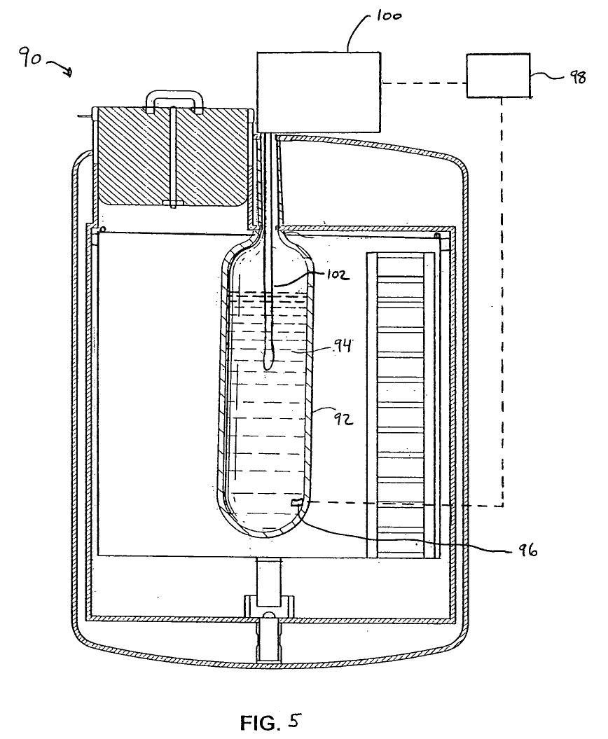

In a fourth embodiment of the cryogenic dewar of the present invention, indicated in general at 90 in FIG. 5, the pressure vessel 92 inside of the cryogenic freezer stores the cryogenic refrigerant 94, which is preferably liquid nitrogen. While a single-walled pressure vessel is illustrated, a double-walled pressure vessel could be used instead. The pressure vessel 92 is equipped with a temperature or pressure sensor 96. The sensor 96 communicates with an automatic switch or microprocessor 98 which in turn communicates with mechanical refrigeration device 100. As a result, the refrigeration device 100 is activated by the pressure vessel's pressure or temperature detected by sensor 96. More specifically, when the pressure or temperature sensor 96 detects that the temperature of the liquid nitrogen 94 is too warm, switch 98 activates refrigeration device 100 which cools the liquid nitrogen in the pressure vessel via the evaporator or cold end 102. As a result, the heat from the liquid nitrogen 94 is mechanically removed from the system without sacrificing the utility of a cryogenic liquid cooled dewar. This creates a mechanical freezer or dewar, with uniform user selectable temperatures, that maintains the long standby time of a liquid cooled freezer or dewar. Suitable mechanical refrigeration devices 100 are well known in the art and are available, for example, from the QDrive company of Troy, N.Y.

It should be noted that the position of the pressure vessel 92 in FIG. 5 is an example only. The refrigeration device 100, automated switch 98 and sensor 96 could be used with the pressure vessel positioned as in FIGS. 2 or 4 or in any position where the pressure vessel is permitted to communicate with the interior of the dewar.

In addition to the improvements resulting from the inclusion of a mechanical refrigerator to a cryogenic dewar in the manner described above, the refrigeration system itself is improved by its inclusion in the system. More specifically, in a typical mechanical freezer, the evaporator (cold end) of the refrigerator has to be quite large to work efficiently. This is due to icing of the cold surface that occurs since it is in direct contact with the air in the freezer. Water vapor in the air freezes on the evaporator forming an ice layer that impedes the heat transfer between the air inside of the freezer and the evaporator. In the embodiment of the present invention illustrated in FIG. 5, the evaporator or cold end 102 is located inside of the pressure vessel. The evaporator thus is only in contact with the refrigerant fluid (nitrogen or other liquid gas) inside of the pressure vessel. Since this liquid gas is pure and contains no water, a very small evaporator surface may be used, making the entire refrigerator smaller and simpler in construction than typical refrigerators used in mechanical freezers.

An example of operation of a dewar in accordance with the embodiment of the present invention illustrated in FIG. 5 is as follows: A dewar with a heat loss of 10 watts that needs a standby time of 1 month contains ˜90 kg of liquid nitrogen in its pressure vessel to provide a reservoir of liquid that would boil away at a rate of 3 kg/day to cool the dewar if all power was lost. If the dewar was to operate at −180° C. ±1° C., the pressure controlled refrigerator would turn on when the pressure reached 59 psig and turn off when the pressure reached 49 psig. If the power to the refrigerator was lost, the pressure would rise ˜1 psig per hour until the pressure vessel relief valve pressure was reached. On a pressure vessel with a 150 psig relief valve, this would give a minimum no loss hold time of {(150 psig-59 psig)/1} 91 hours. At 150 psig, the nitrogen will have warmed to −167° C. If the power was off for less than 91 hours, no product would be lost, when the power was restored the refrigerator would simply refrigerate the freezer back down to 48 psig. If the power loss exceeded 91 hours, nitrogen gas would be vented at a rate of 3 kg per day until the product was exhausted (30 days later) or until power was restored. To maintain the original performance of the freezer, the nitrogen in the pressure vessel would have to be refilled after a long power outage.

While the preferred embodiments of the invention have been shown and described, it will be apparent to those skilled in the art that changes and modifications may be made therein without departing from the spirit of the invention, the scope of which is defined by the appended claims.

What is claimed is:

1. A cryogenic dewar comprising:
a. an inner tank defining an interior of the dewar;
b. an outer shell surrounding the inner tank;
c. a pressure vessel in communication with the interior of the dewar, said pressure vessel containing a supply of cryogenic liquid; and
d. a refrigeration device in communication with the pressure vessel, said refrigeration device cooling the cryogenic liquid of the pressure vessel.

2. The cryogenic dewar of claim 1 wherein the pressure vessel includes an inner tank and an outer shell.

3. The cryogenic dewar of claim 1 further comprising a sensor in communication with the cryogenic liquid of the pressure vessel and the refrigeration device, said sensor activating the refrigeration device when the temperature of the cryogenic liquid rises above a predetermined level.

4. The cryogenic dewar of claim 3 wherein the sensor is a temperature sensor.

5. The cryogenic dewar of claim 3 wherein the sensor is a pressure sensor.

6. The cryogenic dewar of claim 3 further comprising an automatic switch in circuit between the sensor and the refrigeration device, said automatic switch activating the refrigeration device when the sensor detects that the temperature of the cryogenic liquid in the pressure vessel rises above a predetermined level.

7. The cryogenic dewar of claim 1 wherein the pressure vessel is positioned in a top portion of the interior of the dewar.

8. The cryogenic dewar of claim 1 wherein the pressure vessel traverses the height of the interior of the dewar.

9. The cryogenic dewar of claim 1 wherein the cryogenic liquid is liquid nitrogen.

10. The cryogenic dewar of claim 1 further comprising a turntable positioned in the interior of the dewar.

11. The cryogenic dewar of claim 1 wherein the cryogenic liquid in the pressure vessel is at a pressure above atmospheric pressure.

12. The cryogenic dewar of claim 1 wherein the space between the inner tank and outer shell is vacuum-insulated.

13. The cryogenic dewar of claim 1 wherein the pressure vessel includes a cold finger and where the cold finger is positioned in the interior of the dewar while a remaining portion of the pressure vessel is positioned outside of the dewar.

14. A method of cooling a dewar having an inner tank defining an interior and an outer shell surrounding the inner tank comprising the steps of:
a. providing a pressure vessel;
b. adding a cryogenic liquid refrigerant to the pressure vessel;
c. placing the pressure vessel in communication with the interior of the dewar;
d. providing a refrigeration device;
e. placing the refrigeration device in communication with the cryogenic liquid in the pressure vessel; and
f. cooling the cryogenic liquid in the pressure vessel with the refrigeration device.

15. The method of claim 14 further comprising the step of pressurizing the pressure vessel to a pressure above atmospheric pressure.

16. The method of claim 14 wherein the cryogenic liquid is liquid nitrogen.

17. The method of claim 14 further comprising the steps of:
g. providing a sensor in communication with the cryogenic liquid in the pressure vessel;
h. sensing the temperature of the cryogenic liquid in the pressure vessel with the sensor; and
i. activating the refrigeration device with the sensor when the temperature of the cryogenic liquid rises above a predetermined level.

18. The method of claim 17 wherein the sensor is a temperature sensor.

19. The method of claim 17 wherein the sensor is a pressure sensor.

20. The method of claim 14 wherein the pressure vessel includes an inner tank and an outer shell.
